(19) United States
(12) Patent Application Publication
(10) Pub. No.: US 2019/0030876 A1
(43) Pub. Date: Jan. 31, 2019

(54) METHOD AND SYSTEM FOR USING AN OPEN POUR SPRAY URETHANE PROCESS WITH A SINGLE TOOL FOR TRIM COMPONENTS

(71) Applicant: GM GLOBAL TECHNOLOGY OPERATIONS LLC, Detroit, MI (US)

(72) Inventor: Lorin A. Mazur, Shelby Township, MI (US)

(73) Assignee: GM GLOBAL TECHNOLOGY OPERATIONS LLC, Detroit, MI (US)

(21) Appl. No.: 15/664,992

(22) Filed: Jul. 31, 2017

(51) Int. Cl. B32B 27/40; B32B 5/18; B32B 7/12; B32B 37/12

(52) U.S. Cl. CPC B32B 27/40; B32B 5/18; B32B 2309/105; B32B 37/12; B32B 7/12

(57) ABSTRACT

A method and system of manufacturing are provided for using an open pour process with a single tool for a formation process of a component, the formation process including including using no more than a two-layer structure for the component of a first and a second layer wherein the first layer includes: a composite layer formed of a skin layer disposed on a foam layer, wherein the foam layer serves to support the skin layer and as an adhesive between the skin layer and the foam layer to combine both layers into the composite layer and additionally serves as another adhesive between a second layer which the composite layer is disposed thereon, wherein the second layer is a substrate layer formed of a substrate. Then, bonding using a first and a second half of the single tool, the first layer and second layer together.

### TECHNICAL FIELD

Embodiments of the subject matter described herein relate generally to manufacturing processes for interior and exterior components and more particularly to a method and system for manufacturing components using an open pour process with a combined bonding foam and a spray urethane skin as an adhesive for enabling direct press bonding of the urethane skin to a substrate allowing for a lower mass of the combined bonding foam, substrate and urethane skin used therein and a reduced processing time of an entire bonding process for the component.

### BACKGROUND

Foam plastic polymers are used in manufacturing trim components for an automobile for a variety of surfaces in the interior of an automobile in a closed pour or press laminate process. In the closed pour process, a foam plastic polymer (e.g. polyurethane) is generally injected in a flowable state in between a substrate and an outer skin through an opening and flows throughout a contained space within an interior trim component and expands to fill the space with the polyurethane foam which has been injected. In the press laminate process foam, pre-formed in a tool, is press bonded in an open tool using a spray on adhesive to adhere to the outer skin. The foam used in both processes is provided not only for cushioning the trim component assembly to ensure comfort and safety but also for aesthetics in appearance and to provide a smooth backing for the outer skin.

Current manufacturing processes of the open pour and press laminate process do not provide adequate cost savings in substrates used to allow for lighter and more expensive NF substrates used in the trim component which are more feasible when offset from cost savings by reductions in bonding processes times and material used during the manufacturing process of the trim component. Moreover, in both the closed pour and press laminate process, there are limitations in the foam thickness adding to the cost and mass of the entire trim assembly. Accordingly, it is desirable to provide systems and methods which address these shortcomings particularly of foam thicknesses, mass of trim components, multiple tools used and latency times required during the manufacturing process with respect to the process steps which include as follows: the adhesion of the foam to the skin and subsequently to the substrate as well as associated material costs of the foam, substrate and skin used for the manufactured trim component. Furthermore, other desirable features and characteristics of the present invention will become apparent from the subsequent detailed description of the invention and the appended claims, taken in conjunction with the accompanying drawings and this background of the invention.

### BRIEF SUMMARY

A method and systems using a single tool in an open pour in the form of spray or pour on to either the substrate or skin side of the tool which enables the foam to form consistently between the two layers providing adhesion and cushioning for the assembly. The open pour process using the single tool enables a foam thickness of as little as 1 mm to join the substrate and skin provides a reduction of the foam thickness of up to 5-8 mm.

In one example, a method of manufacturing using an open pour process with a single tool for a formation process of a component, the formation process includes:

using a structure comprising at least a first and second layer for the component wherein the first layer comprises: a composite layer formed of a skin layer disposed on a foam layer, wherein the foam layer serves to support the skin layer and as an adhesive between the skin layer and the foam layer to combine both layers into the composite layer and additionally serves as another adhesive between a second layer which the composite layer is disposed thereon, wherein the second layer is a substrate layer formed of a substrate; bonding, in the single tool, using a first and a second half of the single tool, the first layer of the composite layer comprising: the skin layer attached to the foam layer which in turn is attached to the second layer of the substrate, by spraying urethane into the first half of the single tool to form the skin layer of the first layer, loading the substrate into the second half of the single tool to form the substrate layer of the second layer, and open pouring foam in either the first or second half of the single tool; and finally closing the first and second half of the single tool in a manner to bond both the first and second layer by enabling the foam layer to adhere therebetween whereby forming by the single tool in the formation process the two-layer structure of the component.

The method further includes: spraying urethane to form the skin layer into a mold in the first half of the tool to form the component wherein the sprayed urethane provides a color coat to the skin layer of the component. The method further includes:

forming by the spraying of urethane the skin layer including: an outer skin of the color coat of the component supported by an inner skin of the component which is formed by the open pouring of the foam wherein the inner skin supports and adheres to the outer skin wherein the substrate is a natural fiber substrate and the substrate layer having a thickness of approximately 3.0 mm.

The composite layer includes: the outer skin having a thickness of approximately 0.2 mm, the inner skin having thickness of approximately 0.5 mm, and the foam layer having a thickness of in a range of 2.0 mm to 3.0 mm. The method includes applying with the single tool a uniform pressure map across the foam layer for forming a foam layer with a constant density wherein a plurality of paths of the single tool provide venting for air to escape during the closing step enabling the foam layer to be formed with the constant density. The method includes the formation process using a single tool taking approximately one minute for completion.

In another example, a method for producing a component in a multiple combining step process using a single open cell tool in the multiple combining step process, including: spraying a skin layer in the shape of the component in a mold in a first part of a single open cell tool wherein the single open cell tool comprises a first and a second part; disposing a substrate in a mold of the second part of the single open cell tool wherein the second part opposes the first part of the single open cell tool such that the first and second parts form the single open cell tool; pouring a foam layer on the skin layer within the first part of the single open cell tool so that the foam layer is disposed on the skin layer and adheres to the skin layer or alternately, pouring the foam layer within the second part of the single open cell tool so that the foam layer is disposed on the substrate and adheres to a substrate layer; and combining the first and second parts of the single open cell tool in the combining step process to produce the component by enabling a uniform pressure for adhering of the foam layer and a constant density of the foam layer therebetween to both the skin and substrate layers and for the adhering to occur for both layers during a same predefined time-period.

The same predefined time-period is approximately one minute. The method includes: spraying urethane to form the skin layer wherein the urethane is sprayed in a first part of the single open cell tool. The method further includes: forming by the spraying of urethane an outer skin of a color coat of the skin layer of the component supported by an inner skin of the component formed by the pouring of the foam layer in either the first or second part of the single open cell tool wherein the inner skin supports and adheres to the outer skin.

The substrate is a natural fiber substrate and the substrate layer has a thickness of approximately 3.0 mm. The method further includes: forming a composite layer comprising: the outer skin having a thickness of approximately 0.2 mm, the inner skin having thickness of approximately 0.5 mm, and the foam layer having a thickness in a range of 2.0 mm to 3.0 mm. The method includes: applying with the single open cell tool the uniform pressure across the foam layer by using a plurality of paths of the single open cell tool to provide venting for air to escape during the combining step.

In another example, a system for manufacturing a component in a single tool in an open pour process using the single tool configured in an open cell assembly, the system includes: forming, in a first half of the open cell assembly, a composite layer of an outer skin layer configured in a shape of the component such that the outer skin layer is disposed on an inner skin wherein the inner skin is formed by an open pour of foam onto the outer skin layer in the open cell assembly wherein the inner skin adheres to the outer skin when poured and without a need for a separate adhesive layer;

disposing, in a second half of the open cell assembly, a substrate configured with fasteners for attaching the component wherein a substrate layer comprises: both the substrate and the fasteners; and bringing into contact both the first half and the second half of the open cell assembly to form the component, wherein the component comprising a two-layer structure of the composite layer and the substrate layer wherein the foam by the open pour adheres to both the outer skin and the substrate during a same time-period and without a need for an additional adhesion layer as a result of adhesive qualities of the foam realized upon the bringing into contact both halves of the open cell assembly.

The component includes a two-layer structure of the composite layer and the substrate layer wherein the foam by the open pour adheres to both the outer skin and the substrate during a same time-period and without a need for an additional adhesion layer as a result of adhesive qualities of the foam realized upon the bringing into contact both halves of the open cell assembly. The substrate is a natural fiber substrate and the substrate layer has a thickness of approximately 3.0 mm. The composite layer includes: the outer skin has a thickness of approximately 0.2 mm, the inner skin has thickness of approximately 0.5 mm, and the foam has a thickness of in a range of 2.0 mm to 3.0 mm. The system includes: applying a uniform pressure across the composite layer for forming a composite layer with a constant density wherein a plurality of paths of the single tool provide venting for air to escape when both halves are bought into contact. The same time-period is for a predefined time-period not exceeding one minute to complete when the foam adheres to the composite and substrate layers.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a perspective view of an interior of a vehicle illustrating an exemplary embodiment of trim components in a vehicle in accordance with an embodiment;

FIG. 2 is a schematic of a cross-section view of a portion of a trim component of a vehicle illustrating an exemplary embodiment of a trim component in accordance with an embodiment;

FIG. 3 is a functional block diagram illustrating an exemplary embodiment of a closed pour, press laminate and open pour manufacturing process in a manufacturing process for trim components of a vehicle in accordance with an embodiment;

FIG. 4 is a cross sectional view of a trim component illustrating an exemplary embodiment of trim components manufactured in a closed pour, press laminate and open pour manufacturing process a vehicle in accordance with an embodiment;

FIG. 5 is functional block diagram illustrating an exemplary embodiment of cast skin and foam in manufacturing trim components for a vehicle in accordance with an embodiment;

FIG. 6 is functional flow diagram illustrating an exemplary embodiment of a closed pour manufacturing process for a trim component for a vehicle in accordance with an embodiment;

FIG. 7 is functional flow diagram illustrating an exemplary embodiment of a press bonding manufacturing process for a trim component for a vehicle in accordance with an embodiment;

FIG. 8 is functional flow diagram illustrating an exemplary embodiment of an open pour press bonding manufacturing process for a trim component for a vehicle in accordance with an embodiment;

FIGS. 9A and 9B are illustrations of exemplary embodiments of trim components illustrating an exemplary embodiment of an open pour press bonding manufacturing process for a vehicle in accordance with an embodiment;

FIGS. 10A, 10B, 10C, 10D and 10E are illustrations of exemplary embodiments of an open pour press bonding manufacturing process for a trim component for a vehicle in accordance with an embodiment;

FIG. 11 is functional flow diagram illustrating an exemplary embodiment of an open pour press bonding manufacturing process for a trim component for a vehicle in accordance with an embodiment;

FIGS. 12A, 12B, 12C and 12D are illustrations of exemplary embodiments of an open pour press bonding manufacturing process for a trim component for a vehicle in accordance with an embodiment; and

FIGS. 13A and 13B are illustrations of exemplary embodiments of an open pour press bonding manufacturing process for a trim component for a vehicle in accordance with an embodiment

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, a brief summary or the following detailed description.

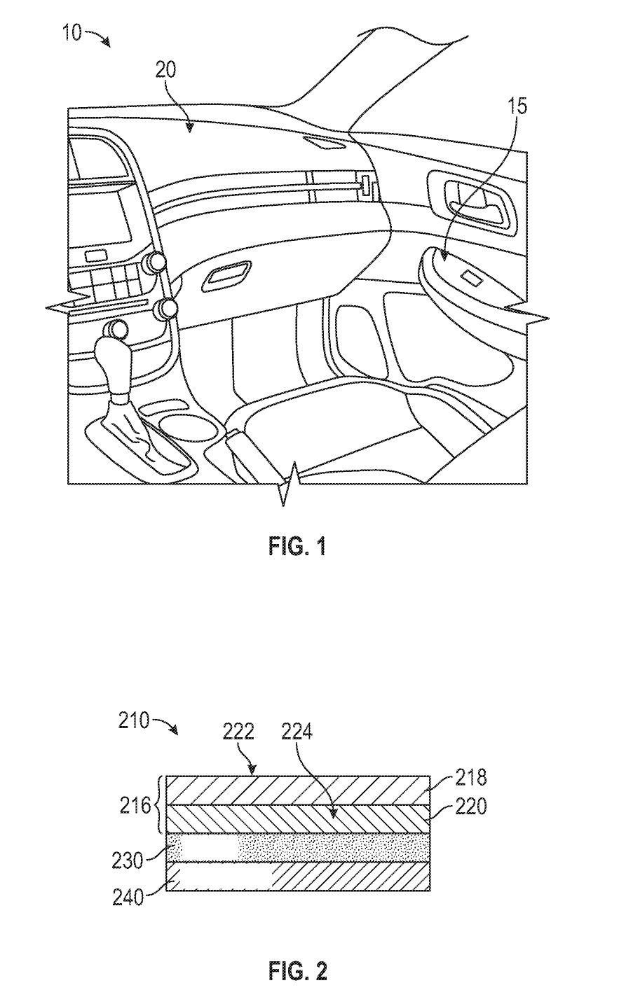

FIG. 1 is a perspective view of an interior of a vehicle illustrating an exemplary embodiment of trim components in a vehicle in accordance with an embodiment. A vehicle may be defined as a vehicle but is not limited to an aircraft, a bicycle, a motorcycle, a boat, a bus, a truck, construction equipment and any means of operation or non-operation that uses a multi-layer urethane skin, foam and substrate component(s) manufactured by the described open tool spray urethane manufacturing process. In an addition, a trim component may be defined as any component that is manufactured by the described manufacturing process. Referring to FIG. 1 an interior 10 of a vehicle is shown with interior trims component representatively shown of a dashboard section 12 and a front arm rest 15 of the vehicle. While a reference is only made to two trim components herein and there are a significant number of such different and like trim components in a vehicle; it is contemplated that the same structure, process of manufacture is used and can be used and applied with respect to the other trim different and like trim components found in a vehicle. A manufactured trim component contemplated may include a shell of a flexible plastic polymer material having a surface of a flexible outer skin of a selected color and texture, a rigid substrate with a foam layer in between which also forms an inner skin, and the substrate. The outer skin formed in a process where the foam layer is adhered to the outer skin and disposed on the substrate. The foam layer serves as a structural support and cushion between the substrate which is rigid and the outer skin which provides the desired texture and color of the surface of the trim component. In addition, while the embodiments are directed to trim components in a vehicle, it is contemplated that the manufacture process of the disclosure may be directed to any similar product needed that uses such process. For example, any product or products found on a bicycle, aircraft, bus, household item may use the described manufacturing product and, as such, the disclosure is not limited to trim components in vehicles.

FIG. 2 shows the multi-layer trim component 210 having distinct layers. The skin layer 216 includes an outer skin layer 218 and an inner skin layer 220. The outer skin layer 218 has an outer surface 222, and an inner surface 224 opposite the outer surface 222. The outer surface 222 may be exposed and viewable from inside the passenger compartment when the multi-layer trim component 210 is installed as the instrument panel as shown in the vehicle section of FIG. 1. The skin layer 216 is disposed on top of a foam layer 230 and a substrate of a substrate layer 240 where the substrate layer 240 provides rigidity for the multi-layer trim component 210.

Optionally, a protective coating can be applied to cover the outer surface 222. The skin layer 216 can be formed in a tool that may be a form and/or a molding tool generally having the shape of the multi-layer trim component 210. The outer skin layer 218 and the inner skin layer 220 can be a variety of materials. In one embodiment, both the outer skin layer 218 and the inner skin layer 220 are a sprayed urethane material, and may be the same or different urethane materials. For example, each may be a urethane material having a different physical property, such as a different hardness, thickness, color, texture, or composition. The outer skin layer 218 may be referred to as a color coat, as it may be used to impart a desired color to the multi-layer trim component 210.

The inner skin layer 220 may be referred to as a structural coat, as it is thicker than the outer skin layer 218 to provide structural support. The texture or pattern can be imparted by the tool or can be created by another mechanical or thermal process. The inner skin layer 220 can then be applied in the tool against the inner surface 224 of the outer skin layer 218. In an embodiment in which the inner skin layer 220 is a sprayed urethane foam, the inner skin layer 220 is applied by spraying, and an outer surface 232 of the inner skin layer 220 can bond to the inner surface 224 of the inner skin layer 220 during spraying, without adding binding adhesives on the outer skin layer 218. As an alternative to sprayed urethane foam, the outer skin layer 218 and the inner skin layer 220 can be other types of materials such as, without limitation, polyurethane, thermoplastic, ethylene vinyl acetate (EVA) foam, expanded foam, polyethylene, polyvinyl chloride (PVC), or a bio-based foam material.

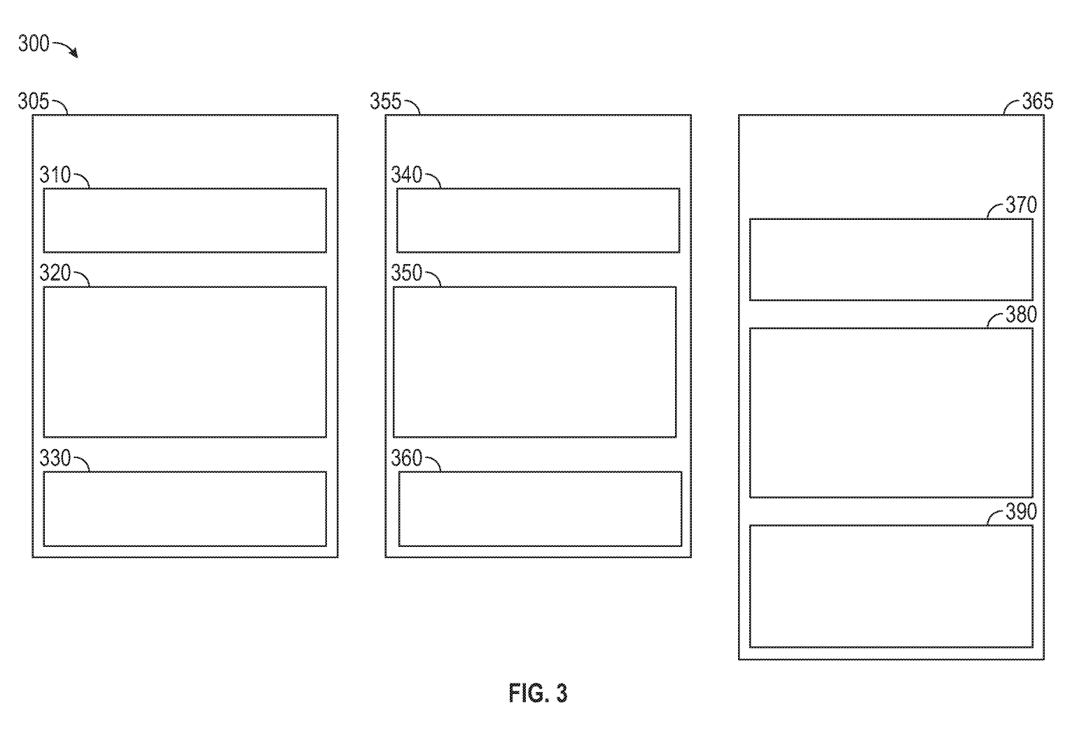

FIG. 3 is a functional block diagram illustrating an exemplary embodiment of a closed pour and press laminate process along with the open pour manufacturing process used which has a spray urethane as a skin adhesive for press bonding to form the trim component in a manufacturing process for a vehicle. The functional block diagram in FIG. 3 illustrates comparisons of the closed pour process 305, the press laminate process 335 and the open pour press bonding process 365 with spray urethane skin.

The closed pour process 305 includes a substrate 310 which provides shape and structure to the trim component. The substrate used is generally of a plastic polymer material and is configured to a particular component of the interior section of a vehicle and may include integral fasteners for securing the particular component to the vehicle. The substrate 310 may be injection molded or alternatively other processes may be used including compression molding and vacuum compression molding to create the substrate 310. In the closed pour process 305, an injection molded substrate of substrate 310 of 2.5 mm to 3.5 mm is used. The substrate 310 supports the foam layer 330 where the foam layer 330 in a separate step is disposed on the substrate 310. The substrate 310 may be placed in contact with the foam layer 330 when the foam layer 330 is curing or has cured. In the latter process, if the foam layer 330 has cured an added bonding adhesive is needed. That is, using a separate mechanical compression step in the tool, the substrate 310 and the foam layer 330 are mechanically sandwiched together in the tool with a bonding adhesive applied either to the foam layer 330 or to the substrate 310 prior the compression. The adhesive may be applied uniformly on the substrate 310 or foam layer 330 or follow a particular spray pattern. Alternately, the foam layer 330 or substrate 310 or both may be heated utilizing the thermoplastic properties of the foam to enhance the bonding together of the foam layer 330 to the substrate 310. While in the former process, if the foam layer 330 is still curing, the foam layer 330 itself acts as an adhesive and therefore no additional adhesive is necessitated and the foam layer 330 is secured to the substrate 310 by the foam layer 330 thermoplastic properties of adhesion. If the foam layer 330 is still curing, then the bonding generally occurs in the tool; While if the foam layer 330 has been cured, the bonding may occur outside the tool with the spray on adhesive. Further, the skin 320 may be already attached if the foam layer 330 has been cured so that substrate 310 and foam layer 330 would also include the outer skin 324 at this stage in the manufacturing process.

The foam layer 330 once cured may form an inner skin of skin 320 at the surface of the foam layer 330 which in the bonding process, the inner skin would bond with the outer skin. The outer skin of the skin 320 is customarily a urethane sprayed skin without a binding adhesive and is sprayed on and can be selected to a desired color or texture or mixture of both during the spray process. The pattern may be created by the tool or by an additional mechanical compression step to impart a pattern or texture on the outer skin. In an exemplary embodiment, the skin 320 which is used may consist of an outer skin of a urethane slush molded skin of 1.8 mm to 2.4 mm in thickness. The outer skin would also be a spray skin urethane skin and may likely be of a different color than the inner skin or be the desired color and have a lesser thickness in a vicinity of 1 mm and when sprayed in a mold. In addition, the sprayed-on skin in the mold forms the shape of the trim component.

In an alternative embodiment, the outer skin maybe formed by a thermoplastic olefin (TPO) plastic in a vacuum (VAC) process and have a thickness of 1-1.2 mm. For example, in an exemplary embodiment, a heated sheet of TPO plastic of thickness of approximately 1-1.2 mm is placed over a mold which may or may not be part of the tool which is then pressed against it to create a seal by vacuum. That is, the application of a vacuum draws out the air between the mold and the heated sheet so the TPO conforms to the mold exactly which may form the shape of the trim component. The mold may also contain an integrated water cooling system which brings the temperature of the TPO plastic to the required curing temperature. Once the curing temperature is reached and the piece is formed, air is blown back into the mold separating the TPO plastic skin from the mold.

The outer skin is disposed on the inner skin making up the skin 320 and the inner skin provides the structure or structural coat necessary for the trim component, hence the outer skin is generally of a greater thickness than the outer skin necessitated by the need to provide the required structure and form of the trim component. The outer skin provides the aesthetics and touch and feel of the surface qualities of the trim component. While the inner skin may provide the added overall cushioning, malleability, and hardness of the underlying surface qualities of the outer skin of the trim component.

The foam layer 330 uses a bonding foam with a thickness of 6-8 mm of urethane foam which may be pre-formed or cured in the tool. The closed pour process 305 requires a thickness of 6-8 mm of the urethane foam to allow for uniformity in the flow of the foam which results higher foam densities and mass because of the necessitated 6-8 mm thickness. The pliable plastic materials used is not limited polyurethane types of plastic, but it is contemplated that materials may be used may include chlorinated polyethylenes, polyethylenes, polypropylenes, ethylene vinyl acetate, poly vinyl chloride, thermoplastic elastomer, acrylic-styrene-acrylonitrile and other thermoplastics or bio designed products and the like.

Continuing with a reference to FIG. 3, the press laminate process 335 includes a rigid non-pliable substrate which is generally injection molded of a thermoplastic material. In FIG. 3., an injection molded substrate 340 of approximately 2.5 mm thickness for rigidity is used. The skin 350 is a poly vinyl chloride (PVC) blend which may be heated and formed under vacuum and pressure to provide the outer shaped skin of the trim component. In an exemplary embodiment, the skin 350 is a calander composite of a VAC form poly vinyl chloride (PVC) which has a thickness of 0.7 mm and open cell form thickness of 3.0 mm. The skin 350 is a compression formed TPO of thickness of 0.7 mm and disposed on an open cell polypropylene (PP) foam of thickness of 3.0 mm which is used to provide structure to the skin 350. A bonding 360 is performed by compression using a spray on adhesive. The adhesive spray for bonding 360 is uniformly or by a sprayed pattern sprayed on the injection molded substrate 340 and skin 350 that are joined together in the foaming process.

The injection molded substrate 340 and skin 350 are joined by foaming using a two-portion or part mold assembly configured in an open cell where the open cell has two part which may be labeled a part or half “A” and a part or half “B”. In an exemplary embodiment, the “B” half contain the skin 350 and the “A” half may contain the injection molded substrate 340. The two mold halves of the cell “A” and “B” are closed together in a manner when engaged to allow for an internal cavity in between the skin 350 and the injection molded substrate 340 in which foam type precursors are injected may be provided. Upon engaging the mold halves of the cell, the liquid precursors exothermally react and expand to fill out the open space. The foam precursors may be provided into an open mold cell, where the two mold halves “A” and “B” are initially separated and the foam precursor is sprayed uniformly in either half and then the mold halves of the cell are put together to seal the foam precursors which will then expand between the skin 350 and injection molded substrate 340. In the exemplary embodiment, the open cell would consist of PP foam having a thickness of 3.0 mm.

With a continued reference to FIG. 3, the open pour press bonding process 365 with spray urethane skin includes a compression molded PP natural fiber substrate of a substrate 370 with a skin 380 of spray urethane sprayed to shape of thickness 0.2 mm which forms the color coat, 0.05 mm structure coat and 2.0-3.0 mm thickness of expanded urethane bonding foam which remains tacky when curing for 3-4 minutes for adhesion all in an “A” side of the cell. That is in the mold, in the forming and bonding 390 of the mold a “B” half of the mold side includes a heated NF substrate of a substrate 370 which is bonded in one step to the “A” side of the mold using sprayed urethane skin of a skin 380 as the adhesive. This bonding occurs during when the expanded skin of skin 380 cures in the 3-4 minutes when the skin 380 remains tacky and serves as the both the skin 380 of the trim component and the adhesive for the substrate 370 to the skin 380. That is, the use of open pour foam in the form of a spray or a pour on either the substrate 370 or skin 380 side of the tool enables the foam to form consistently between the 2 layers providing adhesion and cushioning for the assembly. The open pour enables a foam thickness of as little as 1.0 mm to join the substrate 370 and skin 380 providing a reduction of the foam thickness of 5.0-8.0 mm less. The open pour of the press bonding process 365 is provided to have a completed assembly with one tool with less assembly stations and a reduced cycle time to form the overall assembly. The reduction in thickness and density of the foam in turn provides a reduction in cost and mass. Also, by thinning the spray urethane to 0.7 mm spray volume the cycle time of each trim component produced is reduced balancing the operations needed to produce a final assembly while reducing the amounts of tools required to produce an overall assembly. The process shows a mass reduction of 10% during the rolling of the article of manufacture and a 25% reduction of the closed pour processing of urethane components. Hence, less materials and less steps are required to produce the trim component which enables a reduction in cost of the assembly and the cost of tooling to produce the trim component.

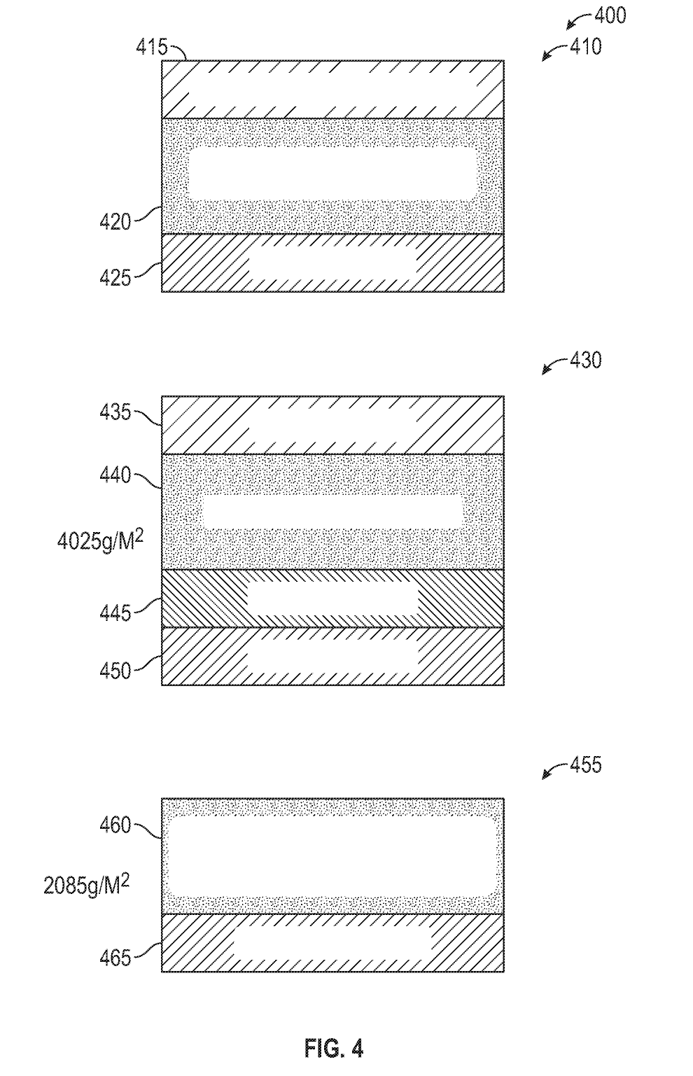

FIG. 4 illustrates a cross section view of the cross sections of the closed pour process 410, the press bonding process 430 and the open pour spray urethane of the open pour press bonding process 455. In the closed pour process 410 the mass per meter is approximately 6000 g/m² and a majority of the mass is contributed by an 8.00 mm foam layer 420 of urethane foam for bonding the substrate 425 and the skin 415. The resultant thickness of the foam layer 420 is due in part to the expansion qualities of the foam after it is injected in the closed cell. The foam layer 420 is disposed on a substrate 425 with a 3.00 mm which is rigid in structure. The thermoplastic qualities of the foam layer 420 when disposed on the rigid layer of the substrate 425 enable bonding during a curing of the foam layer 420 omitting the need for a spray on adhesive layer. Likewise, during the curing, a 1.0 to 2.0 mm TPO or urethane skin of a skin 415 layer which can be placed in the other half of the cell in the mold and is disposed on the foam layer 420 during the closed pour process 410. Hence, for the closed pour process 410 a total thickness of the low range of 12 mm to the upper range of 13 mm is necessitated for the trim component when taking account all three layers.

In the press bonding process 430 requires an additional layer of an adhesive as the foam layer 440 is already cured prior to being disposed on the substrate 450. The press bonding includes a skin 435 disposed on a foam layer 440 of an open cell foam pre-formed from calander sheets with an adhesive layer 445 for bonding the foam layer 440 to the substrate 450. The substrate 450 is of a thickness of about 2.5 mm and the foam layer 440 is of a thickness of 3.00 mm where some reduction may be attributed to the press bonding process 430 itself as well as the preformed calandered foam sheets. The skin 435 has a thickness of about 0.7 mm and is of a TPO PVC material. The adhesive layer 445 has minimal thickness and may be uniformly applied or sprayed on according to a predefined pattern. The four layers of the press bonding process 430 have a mass of about 4025 g/M² or an approximate 30% reduction in mass when compared with the mass of a comparable segment of the cross section from the closed pour process 410.

The open pour press bonding process 455 of the spray urethane bonding is a two-layer structure with a top layer 460 which is a composition of skin material, foam, and adhesive spray skin. That is the top layer 460 is formed of a lawyer of outer skin of 0.2 mm thickness for the color coat, an additional inner skin of 0.5 mm thickness for structural support of the outer skin, the inner skin is part of the foam layer. The foam layer has a thickness of 2.0 to 3.0 mm not including the inner skin. A minimal layer or pattern of adhesive urethane skin is sprayed on either the underside of the foam layer or on the surface of the substrate layer 465. The adhesive layer sprayed on is lessen than the 0.2 mm of the color coat of the outer skin layer. The substrate which is a natural fiber NF substrate has rigidity and is of a thickness of about 3.0 mm. Therefore, the total thickness of both layers, the top layer 460 and the substrate layer 465 is the range of 5.7 mm to 6.7 mm. The mass of a segment of the two layers per a cross section is approximately 2085 g/M². In other words, there is a substantial reduction in thickness from the closed pour process 410 and the press bonding process 430, with about approximately a 50% reduction from the former, and about approximately a 10% reduction of the upper range of the press bonding process 430. Hence, for the press bonding process 430 when compared to the open pour press bonding process 455 there is not a substantial reduction in thickness. Rather, the lack of any substantial reduction and in fact, the actual increase in mass can be viewed when comparing the mass of similar cross section areas. For the closed pour process 410, there is approximately a 60% increase in mass when compared with the open pour press bonding process 455, and for the press bonding process 430 there is about a 50% increase of mass when compared with the open pour press bonding process 455. In an exemplary embodiment, the mass per meter of a trim component segment of each process manufactured can be viewed and compared as follows: for the closed pour process 410 a cross-section segment is shown to have a mass of 6000 g/M² which is approximately 2000 g/M² greater in mass than a similar cross sectional segment of the press bonding process 430; which in turn is approximately 2000 g/M² greater in mass than the open pour press bonding process 455. Additionally, the open pour press bonding process 455 cross-section segment is about 4000 g/M² less than the closed pour process 410 of a similar cross-section segment of the trim component.

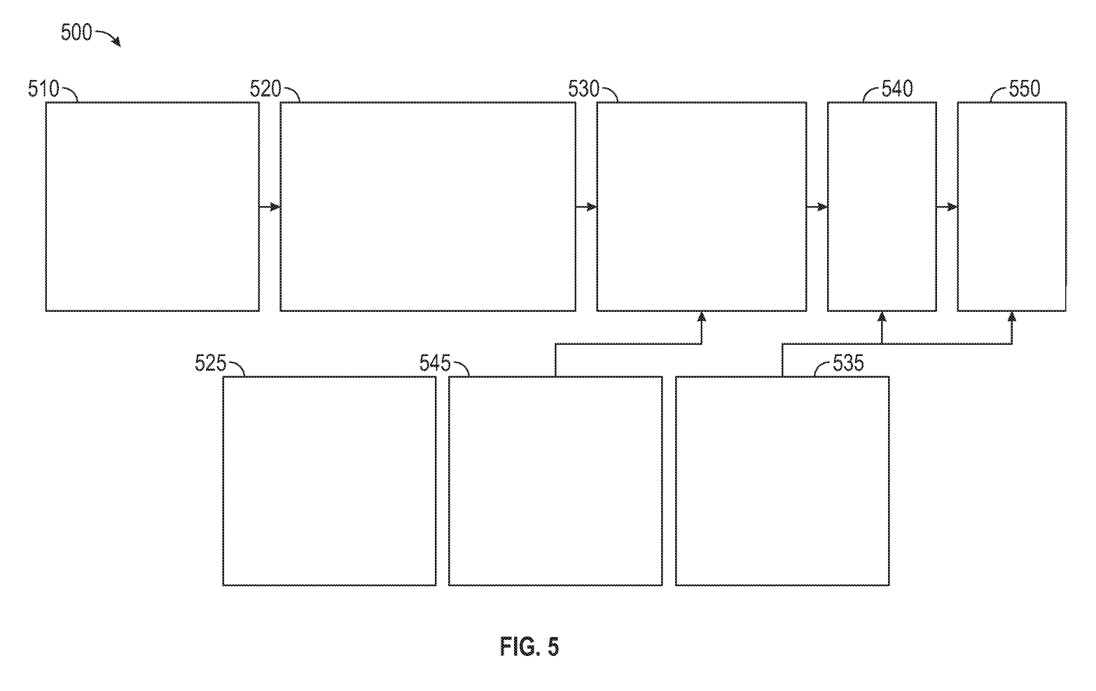

FIG. 5 illustrates sprayed on skin in a mold with cast skin formed in the tool and the added steps when performing a press laminated bonding process. In FIG. 5, an injection mold at 510 is used for the initial injection molding of the substrate. The substrate is placed in one half of a mold. In this case the injection mold is shown for a bolster substrate and an armrest substrate. Next, at 520 a three-in-one (3-1) tool is used, which is one tool that performs three functions which here are spraying, foaming and bonding. The 3-1 tool prays the polyurethane (PU) skin, sprays the foam in a uniform layer or according to a pattern, and may apply a bonding adhesive to bond the substrate to the cover stock. The cover stock is the skin and foam i.e. material that covers the substrate. In an alternative embodiment, cast skin at 530 instead of spray skin may be used. When using cast skin, powder is placed into a heated metal tool and rotated for a period of 2-3 minutes and then removed and trimmed. The removal and trimming are allotted a time of about less than a minute and the cast skin has a thickness of 1.8+ mm similar in thickness to the skin used in a closed pour process. The spray PU skin at 545 has a same process with a shorter cycle time of 1-2 minutes and thickness slightly less of 1.8 mm. At 525 in the stitched version of a cover stock, a spray skin is applied as well as sewing step of the PU spray skin disposed on the foaming cell with the PU skin covering the substrate. At 535, cast skin is place in the foam mold and foam is poured in a closed pour process for 2 minutes. This is performed after the edge wrap at 540 of the cast skin in the mold and subsequently after the foam is poured and cured, the final door assembly takes place at 550.

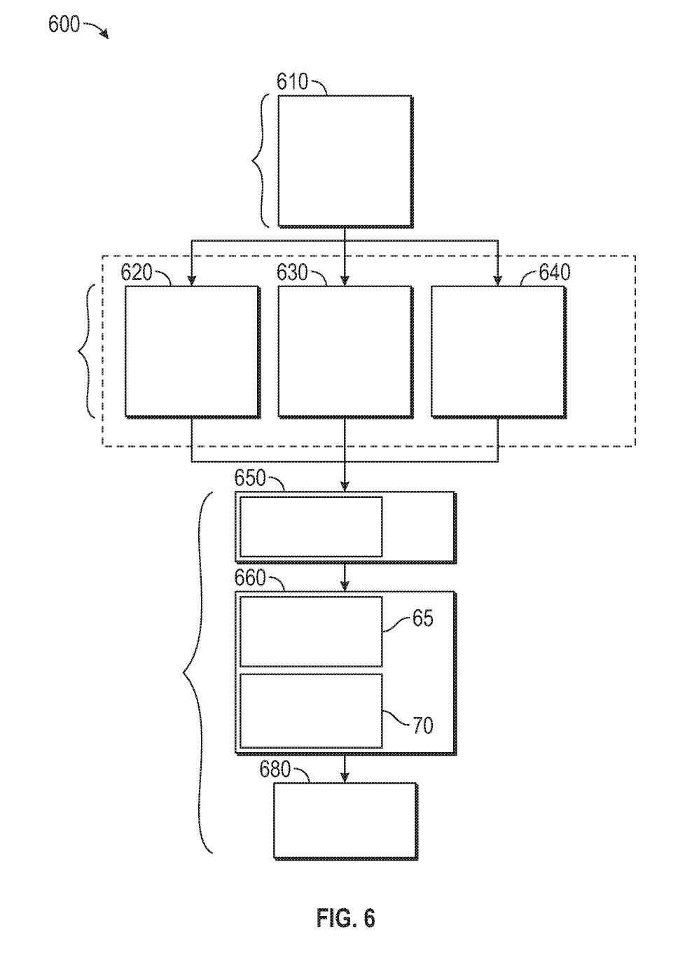

FIG. 6 illustrates a diagram of the press bonding process using a PU spray as a skin and as an adhesive. The press bonding process 600 includes an initial step of a full injection molding cycle 610 of molding of about 60 seconds to form the 2.5 to 3.5 mm rigid substrate. Next, the skin is created in one of three processes. A first process of urethane slush molded skin 620 where a slush molded skin of 1.8 mm to 2.4 mm is created by a separate rotational heated mold which requires approximately 120 seconds to form the slush molded urethane skin. In the second process of spray urethane skin 630, a spray urethane skin is applied in two layers with heat for approximately 120 seconds. A spray urethane skin is formed with a color coat and structure of approximately 1.0 mm.

In the third process, a TPO VAC heat skin 640 is formed and this requires approximately 60 seconds. The bonding may be characterized in a 2-part process were in the first part, both the skin and foam are loaded into separate tool at 650 where the first tool was used to form the skin in the above process already described. In the second part of the bonding the substrate and skin are loaded into the second tool at 660. At 665, the substrate is loaded in a “B” side of the tool and at 670 the skin is loaded in an “A’ side of the tool and foam is poured in either the “B” or the “A” side of the tool and the tool is closed to bond the entire assembly of the skin, foam, and substrate together where the foam acts as an adhesive.

The foam has a thickness of 8 mm, and at 680, once the bonding is completed; the assembled part is removed and the excess foam is trimmed. This bonding process takes approximately 60 seconds. Hence the overall process time on each of the individual lines, generally, is the neighborhood of 180 seconds or more depending on the movement of the parts to each tool and the final assembly point.

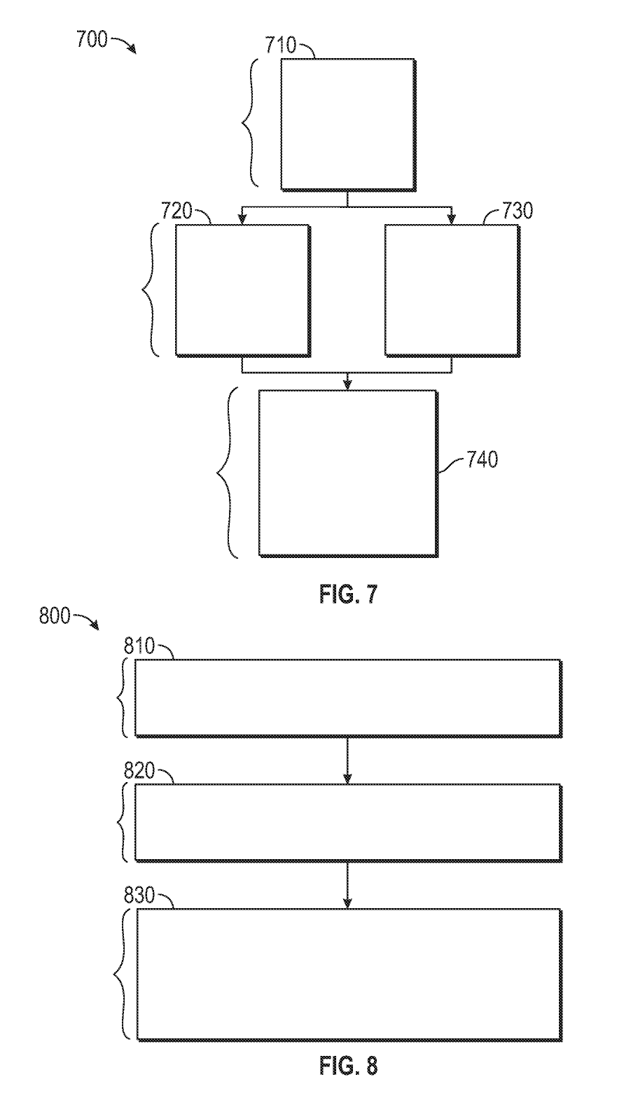

FIG. 7 illustrates the press laminate process 700 with a full injection molding cycle 710 of approximately 60 seconds. There is shown a two-fold option to form the skin at 720 of a first option as a VAC Calander PVC skin formed as the outer skin and the joined to an inner skin of foam which is heated for the joinder and forms the underlying structural support of the outer skin. Alternatively, in a second option, the skin is formed using a TPO heated skin vacuum at 730 to form the TPO skin in the mold. In both cases, the approximate time is approximately 60 seconds for the skin formation. Additionally, the VAC calander PVC skin has a thickness in the vicinity of 0.7 mm and is disposed on the foam which provide by an open pour into the cell and the foam has a thickness of 3.0 mm. While the compression formed skin of the TPO VAC heated skin has a similar thickness in the vicinity of 0.7 mm and the open pour cell of the PP foam has a like thickness in the vicinity again of 3.0 mm. After the skin formation step, a bonding process occurs between the skin, foam and substrate layers. At 740, a substrate is loaded in the “B” side and adhesive spray is applied either uniformly or in a pattern to the substrate and/or skin and is disposed where the skin is on the bottom and substrate below the foam layer uniformly sprayed on and held for 60 seconds for bonding. Alternatively, the substrate may be loaded separately into the cell once the adhesive is applied to the skin or foam layer and would subsequently be bonded to the skin and foam layer. The process time on each of the individual lines is approximately 120 seconds and does not include moving the substrate and skin parts to the cell or the final assembled trim component to the assembly point or final line. In addition, there may be additional time for the formation for skin and foam layers which have not be allotted in the 120 seconds' timeframe, hence 120 seconds for the press laminate process 700 would be deemed on the low end or least possible time required given the likelihood for more time needed for the added steps of manufacturing the skin and foam.

FIG. 8 illustrates the spray urethane foam with skin and adhesion for a press bonding process 800. In the open pour process of press bonding illustrated in FIG. 8, the initial step at 810 necessitates that a “B” side of a cell is loaded with molded fasteners which have been separately molded for approximately 20 seconds together with a PP natural fiber substrate heated to 300 degrees for attachment. Hence, the substrate of the trim component already has fasteners integrated to the substrate for faster attaching to the vehicle section on the substrate side. The skin is loaded or sprayed into the opposing side of the cell, side “A” in the tool and forms the trim component in accordance with a mold on side “A”. Further, the spray PU has a color coat of a thickness of 0.2 mm and a PU substrate coat which is also sprayed on of a thickness of 0.5 mm and an adhesion coat also sprayed on with a thickness of approximately 2.0 mm to 5.0 mm. When forming the skin, the color coat is sprayed according to shape so is a of lesser thickness of 0.2 mm than the structure underlying coat also sprayed but with a thickness of 0.5 mm part of or integrated into the PU or urethane foam which remains tacky for 3-4 minutes. This 3-4 minutes is sufficient time for the foam to cure and adhere in side “A” to the skin and the substrate. That is, at 830 the substrate is load in side “B” of the tool and the sprayed skin remains in side “A” of the tool. An open process of the tool is used where the foam is sprayed or injected to either side and then the tool is closed to bond the entire assembly of the trim component. After which, the trim component assembly part is removed and trim, this takes approximately 90 seconds. Hence, the press bonding process 800 uses only a single final station that is fed by two forming stations of the PP natural fiber substrate and the urethane foam and color/structural skin.

In the press bonding process 800, the bonding of the substrate is performed not with a separate adhesive bonding process but a single step of spraying on the foam whereby this enables the reducing skin thickness and foam thickness and as well as loading in the substrate during both the formation and bonding steps which in turn enables a reduced mass for the foam which is used. Thus, this process results in using less materials and not only reduces the mass for a segment of the trim component but also reduces the overall manufacturing costs for each trim component. This one step manufacturing process is enabled by using an open pour process with controlled venting or valves for curing the foam and a closed pour with controlled venting or valves for curing the entire assembly.

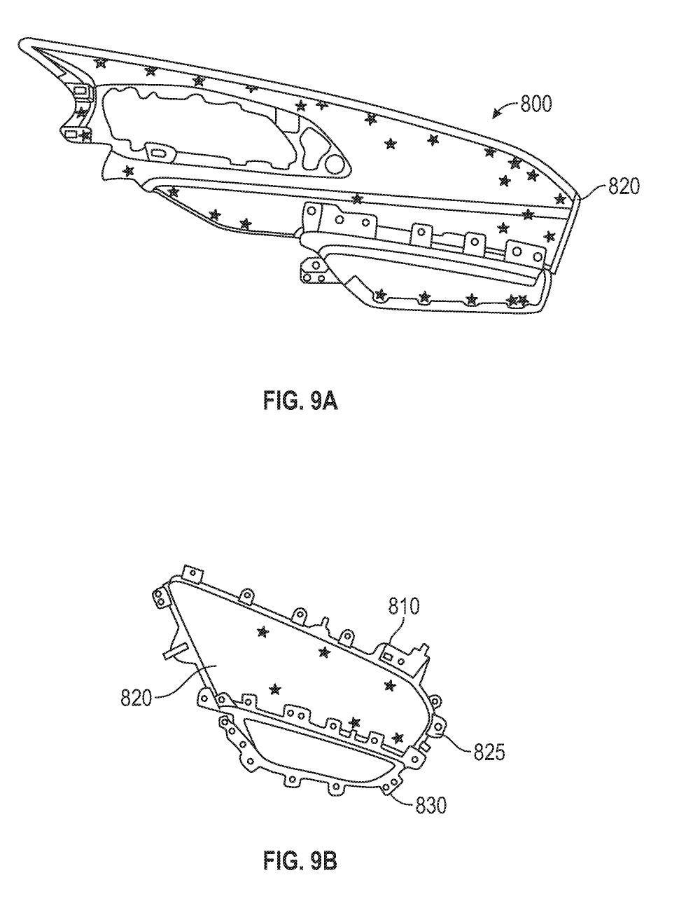

FIGS. 9A and 9B illustrate an assembly of trim components of a foot door bolster/armrest in FIG. 9A and of a rear door bolster/armrest in FIG. 9B. In both trim components, of the front door bolster/armrest 900 and of the rear door bolster/armrest 910, a spray urethane skin 920 is used with a minimized thickness of 0.2 mm for the color coat of the outer skin and a 0.5 mm thickness of the inner skin (not shown) which provides the structural support for the outer skin. Also, a spraying on of urethane foam with a 3.00 mm thickness is used as both an adhesive to press bond back the trim component and the foam can be used for joinder to an injected NF substrate or glass matt substrate. This allows for a reduction in costs and quality improvement by use of a high-grade NF substrate as the underlying rigid support element of the trim component. In the former, of the illustration of the front door bolster/armrest 900 of FIG. 8A, in an exemplary embodiment which is used for the trim component, a substrate is made up of a thin-wall polystyrene material of an acrylonitrile butadiene styrene (ABS) plastic polymer formed by injection molding where a trim component is formed of a combined armrest and bolster with the ABS thin-wall of 1.7 mm and a spray skin of 0.7 mm in thickness. Additionally, a foam in place (FIP) is used with a thickness of 3.0 mm for a total thickness of approximately 5.4 mm. This results in approximate mass reductions of 25-30% because of the reduced cross sectional areas formed and because a material saving in costs is realized from lesser amounts in materials used and reduced processing steps per trim component segment; the overall reductions are approximately 12-17%. In the latter illustration of the rear door bolster/armrest 910 in FIG. 8B, in an exemplary embodiment, there is used for the trim component a substrate having a mass of 1000 g/M² and the substrate used is a natural fiber (NF) polyethylene terephthalate (PET) acrylic resin mold substrate which consists of two sections of a first lower support section 930 and top section 925. Each section 925, 930 has a spray on skin of 0.7 mm thickness and FIP of approximately 3.0 mm thickness. In this instance, more mass reductions are observed of 40-45% while a lesser cost savings of 8-13% is realized due to the complexities of the component process as a result of the two-part structure of the trim component.

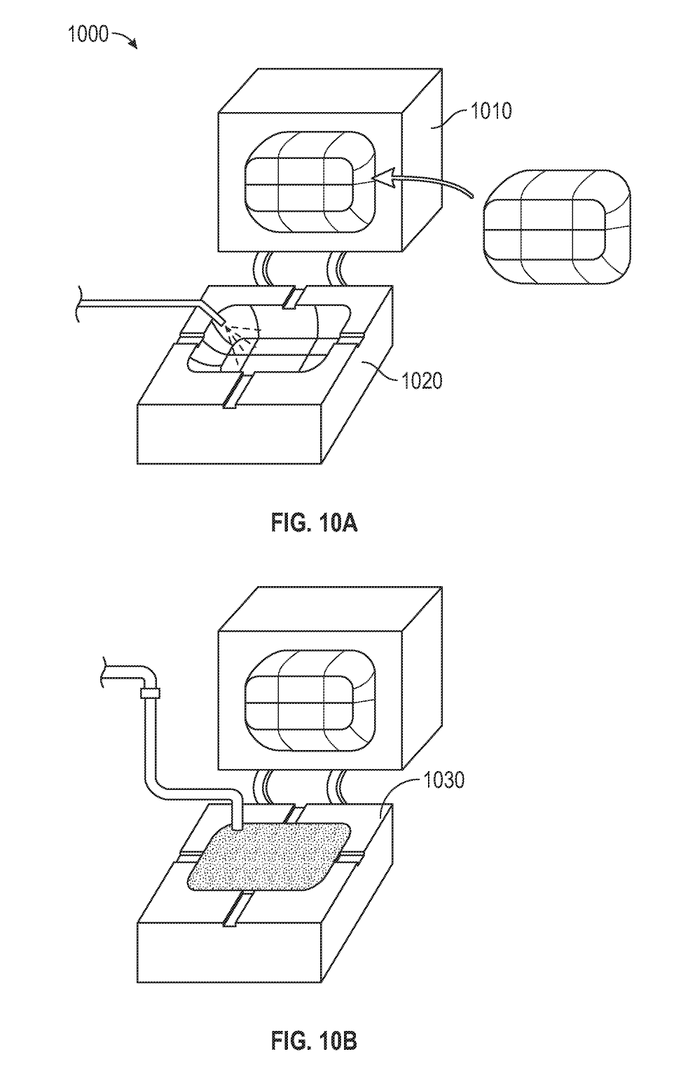

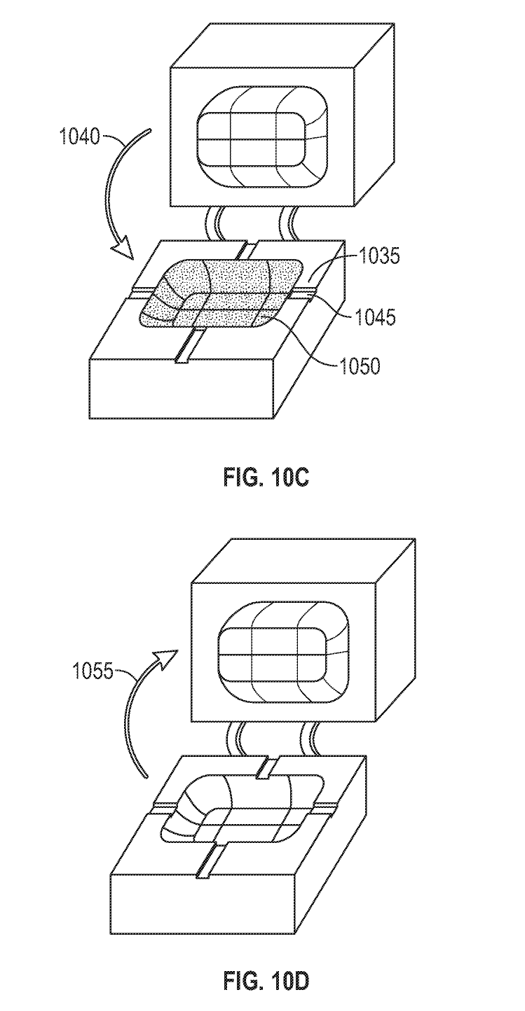

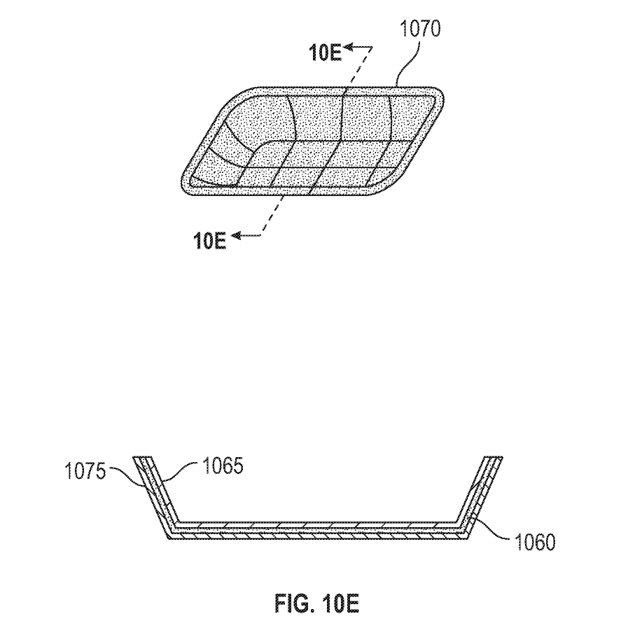

FIGS. 10A, 10B, 10C, 10D and 10E are illustrations of exemplary embodiments of an open pour press bonding manufacturing process for a trim component for a vehicle in accordance with an embodiment;

In FIGS. 10A-E, FIG. 10A illustrates a simultaneous bonding on both sides of the open tool 1000 of a first step in the manufacture of the trim component. In a first instance, the side “A” 1020 of the open tool (where a release has been applied) is sprayed with urethane for an outer skin of the trim component of uniform sprayed urethane at minimum thickness. The skin includes two parts of the first part of the desired color and texture or surface touch of the trim component and the second part a degree of structure at minimum thicknesses to enable fast cure times and efficient use of urethane material. In the first step of FIG. 10A, a time-period of approximately 60 seconds is needed to apply and for the cure process to begin and end for this segment of the manufacture process and results in a skin of a thickness of approximately 0.7 mm. On the other side of the open tool 1000, within the same time-period or simultaneously, in opposing side “B” 1010 of the open tool a compression molded or injected substrate such as natural fiber or glass fiber is vacuum formed or mechanically held and trimmed in same clam shell mold for approximately 60 seconds and has a 1.0-3.0 mm thickness. In alternate exemplary embodiments, a fully formed substrate may be loaded into side “B” 1010 and may be already formed from manufacturing processes such as compression, injection molding, casting or stamping based on cost feasibility metrics and other requirements such as safety, strength, or mass needed. In addition, other potential materials for the substrate formed can be any natural fiber, any injection molded material, any metal, and/or glass fiber materials etc. It is contemplated that the first step has a cycle time of approximately 60 seconds for both formations of the skin and substrate and that the total cycle time including the spray on, pour on or loading activities not exceed a total of cycle time is approximately 80 seconds.

In FIG. 10B foam pour or spray is also applied within the same time-period on the opposing side “A” 1030 or core side while the tool is in the open or in a release position. That is, in the open tool 1000 in side “A” 1030 during the cure time of the spray urethane previously added, on top of this spray urethane layer, a layer of expanding urethane foam which acts as a bonding agent or bonding urethane foam layer is added by either pouring or spraying in the cavity on side “A” 1030 of the open tool 1000. This spraying process is about 10 seconds, and may be executed or enabled within the prior time prior 60 second time-period allotted for the spray urethane skin layer depending on the complexity and latency time of the surface being sprayed. That is, if the spay urethane layer is completed in a less period time, then the foam spray may begin, or may even begin during a time-period after spraying of the urethane skin layer has started but not completed. In other words, simultaneous spraying of the bonding of the bonding foam layer may occur with the compressed or injected substrate layer in side “B” 1010 of FIG. 10A. This has the effect of further reductions in the manufacturing time of the creating the multi-layers of the trim component by using the single open tool during the open press lamination process.

In FIG. 10C the open tool 1000, previously in an open position during the spray or injections processes, is from an open clam shell manner, closed in a closing operation 1040 where a bonding or adhering of the substrate layer and the skin layer by surface to surface compression occurs. As a result of the compression, excess foam is channeled away from the foam layer to allow for a uniform smooth foam layer without gaps and for additional uniformity in density and foam thickness. In addition, the compression of the foam layer by the closing operation 1040 allows for a layer of foam thickness which is reduced by the force of compression to less than 6.00 mm. In other words, the resultant foam layer of about 2.00-3.00 mm in the open pour press bonding with a single tool and spray urethane skin process; is significantly less than in the close pour process where an 8.00 mm foam layer is required. The reduction is at least 20% less (if the 6.00 mm upper limit is used) or about 62.5% less if the foam layer is about 3.00 mm in the closed pour process which is similar to the press laminated process where the foam layer is about 3.00 mm. In the open pour spray with press bonding, the composition layer allows for 2.0-3.0 mm layer of bonding foam.

With a continued reference to FIG. 10C, the substrate layer and skin layer are joined together by the expanding foam after the tool is closed using an open pour process. The uniform pressure mapping of the foam expansion is critical to after the tool is closed to enable a consistent density of the expanding foam in thinner section between the substrate and the skin layer depending on the form of the trim component. This consistent density is enabled by providing controlled paths 1045 for the air in the cavity to escape.

The controlled paths 1045 may be edge vents 1035 of varying sizes cut into tool itself. In alternate exemplary embodiments, holes 1050 may be cut into the substrate in critical areas around the trim component to allow for pathways for air or gases formed or may be forming in the substrate and/or foam layers during the open pour process to escape and to vent from behind the substrate rather than through paths 1045 or in conjunction with the paths 1045 of the tool itself. These holes 1035 may be created by variety of methods including by a mold of the substrate with a plurality of voids or holes. In addition, grommets may be used and attached to the substrate as well as recesses preformed in the mold of the substrate layer. Additionally, the vented air or gases may be vented in a controlled manner for desired affects to the substrate or foam layers. For example, perimeter mechanical or hydraulic gates, and/or pneumatic bags (not shown) also provide opportunities to control the escape of air in the correct location of the trim component to enable thin foam sections and uniform density of the foam. The tool remains closed for the foam layer and the skin layer to cure as well as for a complete bonding of the entire multi-layer assembly of the trim component. In an exemplary embodiment, a mechanical edge wrap operation can occur during the time-period when the foam layer is curing. By performing the mechanical wrap during the time-period of the foam curing and there would not be any added time to the latency time of the curing process. The polyurethane spray skin is commonly used to wrap the foam of trim components.

In FIG. 10D, the closed tool is opened in an opening process 1055 to remove the bonded and completed assembly 1070 of the trim component. The trim component of the completed assembly 1070 is in the form of the final trim component with a multi-layer cross-section “A” illustrated in FIG. 10. At this stage, the trim component formed or assembly 1070 is ready for a final trim and an edge wrap if required. In FIG. 10E, the cross-section “A” of the assembly 1070 has a skin layer 1075 which is the outer layer, the foam layer 1060 which is the bonding middle layer which the skin layer 1075 is disposed on and the substrate layer 1065 which the foam layer 1060 is disposed on. The substrate layer 1065 provides the rigidity of the trim component and the foam layer 1060 provides the cushioning and support for the skin layer 1075. The skin layer 1075 provides the overall aesthetics and look and feel of the trim component. The excess foam if any from the foam layer 1060 is removed and manufacturing process is repeated for the next trim component again. While FIG. 10E, the cross-section “A” is describe with a skin layer 1075 and foam layer 1060, a composite layer (not shown) may be described as combination of the skin layer 1075 and the foam layer 1060. Hence, it is contemplated that a two-layer of a composite layer and substrate layer 1065 may also describe such a cross-section “A”.

In the exemplary embodiment, using for the manufacture of the trim component, the open pour process described with a closed tool operation and cure time is 60 seconds, would enable a part of a trim component to be produced or processed approximately every 90 seconds when two tools and one machining device are used for the complete assembly. That is, as an example, the first tool may be used to create the substrate and/or skin layer; while the second tool is used for the foam layer bonding and curing. In the case of one machine and one tool, a manufacture of a part of trim component would be approximately 150 seconds. There is a reduction of at least 50% of manufacture processes that require a minimum of 3 machines, 3 tools, and 180 to 300 seconds plus material handling

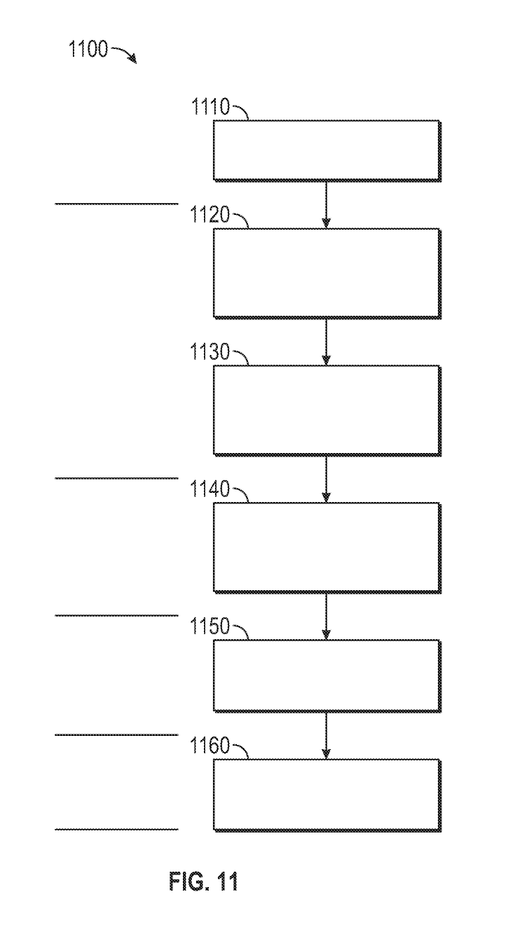

FIG. 11 is functional flow diagram illustrating an exemplary embodiment of an open pour press bonding manufacturing process 1100 for a trim component for a vehicle in accordance with an embodiment. In FIG. 11, initially, the tool is in open position at 1110. In step 1 which is about 60 seconds, the skin is formed in side “A” and the substrate is formed in side “B” of the tool in the open position 1110. At 1120, in step 1 at side “A”, spray urethane at minimum thickness is applied as has two parts of color/touch and structure with minimum thicknesses which enables a fast cure time and an efficient use of material. For this step 60 seconds is approximately required to apply the spray urethane skin and begin the cure for a skin layer of total thickness of about 0.7 mm. Also, at 1130, in step 1, in side “B” of the tool a compression molded substrate such as natural fiber or glass fiber is vacuum formed and trimmed in same clam shell mold. This takes about 60 seconds and forms a substrate of 1.0-3.0 mm in thickness. Step 1 generally takes no more than 80 seconds when including time for material handling or loading etc. In step 2, at 1140, in side “A” during the cure time of the spray urethane skin, the expanding urethane bonding foam is added by either pouring or spraying. This step 2 takes about 10 seconds and may be enabled in the previous time-period allotted depending on the complexity of the surface being sprayed. Hence, steps 1 and 2 take about 90 seconds. In step 3, at 1150, the tool is closed and the substrate and the skin are joined together by the expanding foam after the tool is closed using an open pour process. At 1150, a uniform pressure mapping is applied by the closed tool of the foam expansion and is a critical step as this uniform pressure mapping enables a consistent density of the expanding foam in thin sections of the trim component and as well as a consistent density of the foam by providing controlled paths for the air in the cavity and/or foam to escape during the pressure mapping. The time for step 3 is 60 seconds for the joinder of both layers. In step 4 the tool is opened to remove the trim and wrap, at 1160, the tool initially remains closed for foam layer and skin layer to properly cure as well as a complete bonding to occur of the assembly. Subsequently, the tool is opened to remove a completed assembly which is ready for the final trim and edge wrap if required. Also, any excess foam if any is removed and process for the next trim component begins and the process is again repeated as needed in the manufacturing of the particular trim component. The total time is about 150 seconds for all the steps 1 to 4.

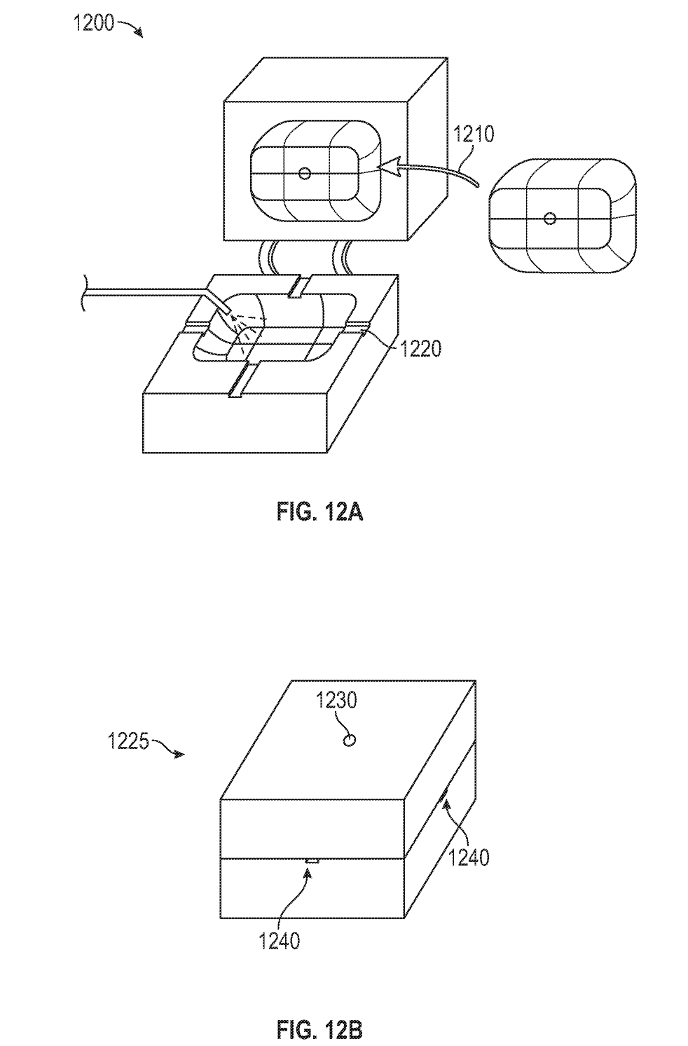

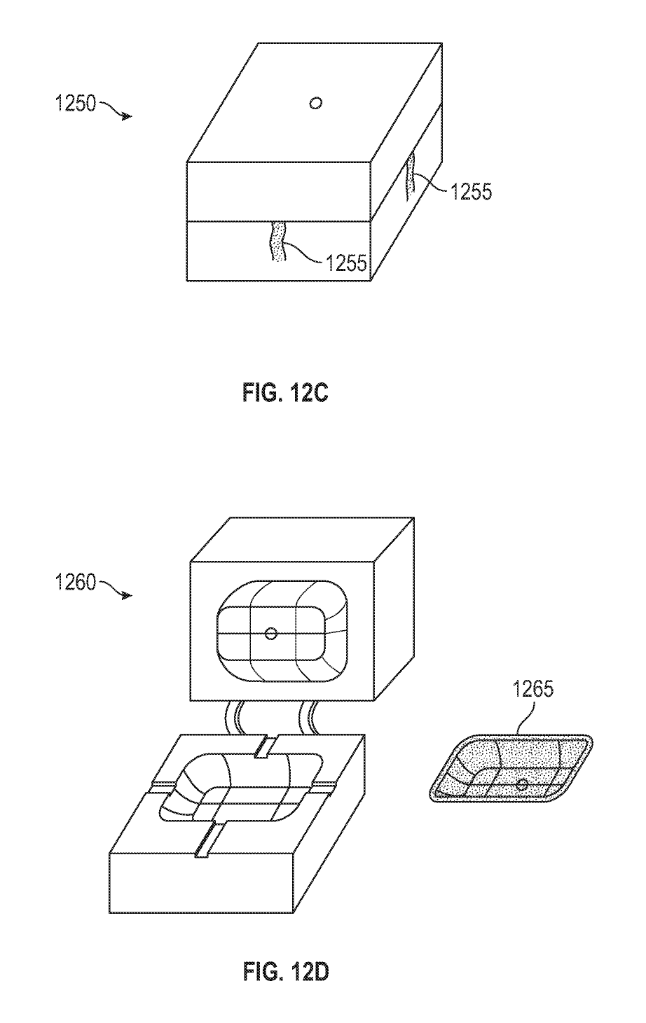

FIGS. 12A, 12B, 12C and 12D are illustrations of exemplary embodiments of a close pour press bonding manufacturing process for a trim component for a vehicle in accordance with an embodiment. FIG. 12A illustrates a closed pour with press relief with, initially, an open tool 1200 where a release is applied and a spray urethane layer for color and structure is applied to a side of the open tool 1200; while in an opposing side of the open tool 1200, a substrate is poured or injected 1210. The urethane layer and the substrate layer are therefore separated and not in contact during the initial formation step as both layers are formed or in the process of being formed at the onset in opposing sides or portions of the open tool 1200 while the open tool 1200 is in an open position. In the open tool 1200 there are a set of pressure relief valves 1220 which are placed or integrated into the open tool 1200 in a manner that upon closing of the open tool 1200, the pressure relief valves 1220 allow for pressure to be release by one or more of the pressure relief values 1220 in a convenient manner.

The pressure is a result of foam which has been injected or poured into the open tool 1200 while the open tool 1200 is in the open position and into either of the sides of the open tool 1200, and expanding during formation and being brought under pressure by the closure of the open tool 1200 during the expansion. That is, a foam layer is formed between the urethane layer and the substrate layer and upon the closure of the open tool 1200, the foam of the foam layer is not fully cured and may expand and also may be compressed with force applied by the sides of the open tool 1200. The foam layer during the formation, and particularly during the expansion, may contain air and have air gaps or air pockets or may not be uniform in distribution containing recesses resulting in air gaps or pockets in the foam or foam layer. As illustrated in FIG. 12B, the open tool 1200 is closed where one side of the open tool 1200 and the opposing side of the open tool 1200 mesh together or are placed in contact to form a sealed unit with a set of pressure release valves 1240 in between both sides. While the pressure release devices are described as pressure release valves 1240, it is contemplated that a variety of devices may be used for pressure relief. In an alternative embodiment, pressure release devices may include valve gates which surround the foam layer or the other layers or a combination thereof forming a perimeter type configuration. The valve gates are used during expansion in wall sections smaller than 3.0 mm. The valve gates could be adjusted to modulate the release of the gas pressure for enabling a uniform pressure map to be applied across the foam layer during the foam expansion while preventing the release of foam to the exterior of the closed tool 1225. In addition, other perimeter type configurations may include different pressure devices integrated or used in conjunction therewith in the form of airbags, bladder seals, or any other of a number of mechanical or pneumatic devices that enable or can create an uniform pressure mapping of the foam layer during an expansion by controlling the release of air. Additionally, pressure release devices 1230 may be placed through or with the substrate or urethane layers and may be found on a top and on a bottom side or portion of the closed tool 1225.

In FIG. 12C, during the closure of the closed tool 1250, through a singular or a multiple set of pressure release devices 1255, the pressure is released from the closed tool 1250 and excess foam in instances may be allowed to flow through the pressure release devices 1255 to control the pressure. That is, the pressure release devices 1255 in an exemplary embodiment, may be pressure valves or gates that allow for both the air and foam to exit for pressure reduction and for uniform mapping of pressure to the foam layer as well as, and also in stances, to the urethane and substrate layers. The pressure release devices 1255 can be prioritized if a set of pressure release devices 1255 are needed to be operated to perform the pressure release operations or may simply be actuated all at once or only a particular subset may be used depending on the requirements for the particular trim component and the foam usage and expansion qualities.

In FIG. 12D, the closed tool 1250 (of FIG. 12C) is subsequently opened and the open tool 1260 therein allows for the removal of the final assembly trim component 1265 of the multiple layer trim component of the urethane, foam and substrate or composite and substrate. The final assembly trim component 1265 of FIG. 12D may be trimmed of the excess foam at this stage in the manufacture process.

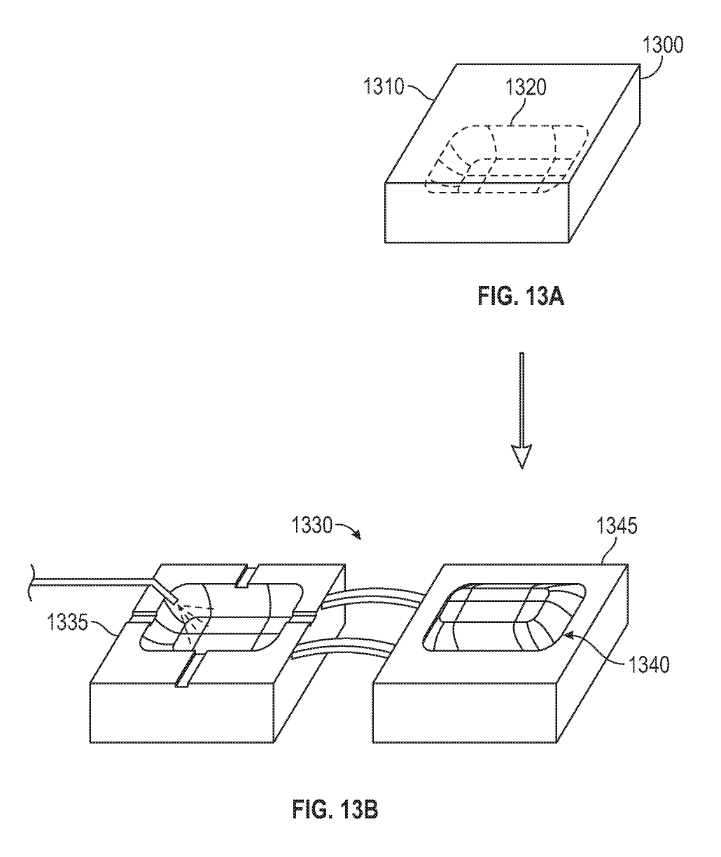

FIGS. 13A and 13B are illustrations of exemplary embodiments of an open pour press bonding manufacturing process for a trim component for a vehicle in accordance with an embodiment. In FIGS. 13A and 13B, an open tool 1330 with foam as an example, is laid open to enable the one tool formation in the manufacture process. In an exemplary example, initially, the compression molded sheet 1310 which may be composed of a variety or number of different substrate types of a natural fiber NF, glass PP, polymer base, carbon fiber etc. is loaded in a side “B” of an open tool which may be laid fully opened. The substrate of the compression molded sheet is configured to a shape 1320 of the component to be manufactured. The shape 1320 is formed from the compression sheet which is formed into the shape 1320 and then deformed and makes up part of the final assembly by of a part in mold 1340 of the tool. The added female half of the upper part 1300 compresses and enables the substrate to be trimmed and to form the complete substrate. In addition, excess material may be formed, that is the excess material is retained and adheres to the upper half or side of the tool by vacuum which enables removal of the excess material by a removal process during the vacuum. Once completed, a new sheet of the compression molded sheet may be loaded to the upper part 1300 or lower part 1345 of the tool. In addition, the upper part 1300 may move down on the lower part 1345 with force and heat for compression of the molded sheet. The spray of the urethane skin can occur simultaneously in 1335 of the laid open tool.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments.

It should be generally understood that various changes can be made in the function and arrangement of elements without departing from the scope defined by the claims, which includes known equivalents and foreseeable equivalents at the time of filing this patent application.

What is claimed is:

1. A method of manufacturing using an open pour process with a single tool for a formation process of a component, the formation process comprising:
using a structure comprising at least a first and second layer for the component wherein the first layer comprises: a composite layer formed of a skin layer disposed on a foam layer, wherein the foam layer serves to support the skin layer and as an adhesive between the skin layer and the foam layer to combine both layers into the composite layer and additionally serves as another adhesive between a second layer which the composite layer is disposed thereon, wherein the second layer is a substrate layer formed of a substrate;
bonding, in the single tool, using a first and a second half of the single tool, the first layer of the composite layer comprising: the skin layer attached to the foam layer which in turn is attached to the second layer of the substrate, by spraying urethane into the first half of the single tool to form the skin layer of the first layer, loading the substrate into the second half of the single tool to form the substrate layer of the second layer, and open pouring foam in either the first or second half of the single tool; and
closing the first and second half of the single tool in a manner to bond both the first and second layer by enabling the foam layer to adhere therebetween whereby forming by the single tool in the formation process the two-layer structure of the component.

2. The method of claim 1, further comprising:
spraying urethane to form the skin layer into a mold in the first half of the single tool to form the component.

3. The method of claim 2 wherein the sprayed urethane provides a color coat to the skin layer of the component.

4. The method of claim 3 further comprising:
forming by the spraying of urethane the skin layer comprising: an outer skin of the color coat of the component supported by an inner skin of the component which is formed by the open pouring of the foam wherein the inner skin supports and adheres to the outer skin.

5. The method of claim 1, wherein the substrate is a natural fiber and the substrate layer having a thickness of approximately 1.0-3.0 mm.

6. The method of claim 4, wherein the composite layer comprising: the outer skin having a thickness of approximately 0.2 mm, the inner skin having thickness of approximately 0.5 mm, and the foam layer having a thickness of in a range of 2.0 mm to 3.0 mm.

7. The method of claim 1, the closing step further comprising:
applying with the single tool a uniform pressure map across the foam layer for forming a foam layer with a constant density wherein a plurality of paths of the single tool provide venting for air to escape during the closing step enabling the foam layer to be formed with the constant density.

8. The method of claim 1, wherein the formation process using a single tool taking approximately one minute for completion.

9. A method for producing a component in a multiple combining step process using a single open cell tool in the multiple combining step process, comprising:
spraying a skin layer in the shape of the component in a mold in a first part of a single open cell tool wherein the single open cell tool comprises a first and a second part;
disposing a substrate in a mold of the second part of the single open cell tool wherein the second part opposes the first part of the single open cell tool such that the first and second parts form the single open cell tool;
pouring a foam layer on the skin layer within the first part of the single open cell tool so that the foam layer is disposed on the skin layer and adheres to the skin layer or alternately, pouring the foam layer within the second part of the single open cell tool so that the foam layer is disposed on the substrate and adheres to a substrate layer; and
combining the first and second parts of the single open cell tool in the combining step process to produce the component by enabling a uniform pressure for adhering of the foam layer and a constant density of the foam layer therebetween to both the skin and substrate layers and for the adhering to occur for both layers during a same predefined time-period.

10. The method of claim 9, wherein the same predefined time-period is approximately one minute.

11. The method of claim 10 further comprising:
spraying urethane to form the skin layer wherein the urethane is sprayed in a first part of the single open cell tool.

12. The method of claim 11 further comprising:
forming by the spraying of urethane an outer skin of a color coat of the skin layer of the component supported by an inner skin of the component formed by the pouring of the foam layer in either the first or second part of the single open cell tool wherein the inner skin supports and adheres to the outer skin.

13. The method of claim 9, wherein the substrate is a natural fiber substrate and the substrate layer has a thickness of approximately 3.0 mm.

14. The method of claim 9, further comprising:
forming a composite layer comprising: the outer skin having a thickness of approximately 0.2 mm, the inner skin having thickness of approximately 0.5 mm, and the foam layer having a thickness in a range of 2.0 mm to 3.0 mm.

15. The method of claim 14, further comprising:
applying with the single open cell tool the uniform pressure across the foam layer by using a plurality of paths of the single open cell tool to provide venting for air to escape during the combining step.

16. A system for manufacturing a component in a single tool in an open pour process using the single tool configured in an open cell assembly, the system comprising:
forming, in a first half of the open cell assembly, a composite layer of an outer skin layer configured in a shape of the component such that the outer skin layer is disposed on an inner skin wherein the inner skin is formed by an open pour of foam onto the outer skin layer in the open cell assembly wherein the inner skin adheres to the outer skin when poured and without a need for a separate adhesive layer;
disposing, in a second half of the open cell assembly, a substrate configured with fasteners for attaching the component wherein a substrate layer comprises: both the substrate and the fasteners; and
bringing into contact both the first half and the second half of the open cell assembly to form the component, wherein the component comprising a two-layer structure of the composite layer and the substrate layer wherein the foam by the open pour adheres to both the outer skin and the substrate during a same time-period and without a need for an additional adhesion layer as a result of adhesive qualities of the foam realized upon the bringing into contact both halves of the open cell assembly.

17. The system of claim 16, wherein the substrate is a natural fiber substrate and the substrate layer has a thickness of approximately 3.0 mm.

18. The system of claim 16, wherein the composite layer comprising: the outer skin has a thickness of approximately 0.2 mm, the inner skin has thickness of approximately 0.5 mm, and the foam has a thickness of in a range of 2.0 mm to 3.0 mm.

19. The system of claim 16, further comprising:
applying a uniform pressure across the composite layer for forming a composite layer with a constant density wherein a plurality of paths of the single tool provide venting for air to escape when both halves are bought into contact.

20. The method of claim 16, wherein the same time-period is for a predefined time-period not exceeding one minute to complete when the foam adheres to the composite and substrate layers.
